(19) United States
(12) Patent Application Publication
(10) Pub. No.: US 2025/0351189 A1
(43) Pub. Date: Nov. 13, 2025

(54) TECHNOLOGIES FOR RANDOM-ACCESS CHANNEL OCCASION SELECTION

(71) Applicant: Apple Inc., Cupertino, CA (US)

(72) Inventors: Peng Cheng, Beijing (CN); Chunhai Yao, Beijing (CN); Dan Wu, Beijing (CN); Fangli Xu, Beijing (CN); Jie Cui, San Jose, CA (US); Seung Hee Han, San Jose, CA (US); Seyed Ali Akbar Fakoorian, San Diego, CA (US)

(73) Assignee: Apple Inc., Cupertino, CA (US)

(21) Appl. No.: 19/097,492

(22) Filed: Apr. 1, 2025

Related U.S. Application Data
(60) Provisional application No. 63/645,050, filed on May 9, 2024.

(51) Int. Cl. H04W 74/0833; H04L 5/00

(52) U.S. Cl. CPC H04W 74/0833; H04L 5/0048

(57) ABSTRACT

The present application relates to devices and components including apparatus, systems, and methods for configuring and selecting random access channel (RACH) occasions.

### CROSS-REFERENCES TO OTHER APPLICATIONS

This application claims priority to U.S. Provisional Application No. 63/645,050, for “TECHNOLOGIES FOR RANDOM-ACCESS CHANNEL OCCASION SELECTION” filed on May 9, 2024, which is herein incorporated by reference in its entirety for all purposes.

### TECHNICAL FIELD

This application relates generally to communication networks and, in particular, to configuring and selecting random access channel (RACH) occasions.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a mapping of synchronization signal block to physical random access channel (PRACH) occasions in accordance with some embodiments.

FIG. 3 illustrates another mapping of synchronization signal block to PRACH occasions in accordance with some embodiments.

FIG. 4 illustrates another mapping of synchronization signal block to PRACH occasions in accordance with some embodiments.

FIG. 5 illustrates an example of a configuration in accordance with some embodiments.

FIG. 6 illustrates an operation flow/algorithmic structure in accordance with some embodiments.

FIG. 7 illustrates another operation flow/algorithmic structure in accordance with some embodiments.

FIG. 8 illustrates a user equipment in accordance with some embodiments.

FIG. 9 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

3GPP specifications may define a physical random access channel (PRACH). A user equipment (UE) may use PRACH to perform a random-access procedure. The UE may perform a random-access procedure for initial access and radio resource control (RRC) connection setup, RRC connection re-establishment, handover, after a scheduling request failure, transition from an RRC inactive state to an RRC connected state, beam recovery, or other scenarios.

The base station may provide the UE with the configurations associated with the random-access procedure through the system information block (SIB). For example, the PRACH configuration index parameter in the SIB may determine the preamble type, sequence length, or PRACH transmission time.

The UE may perform a contention-based random-access procedure, which may be referred to as contention-based random access (CBRA). In contention-based random-access, the UE may randomly select a preamble from a set of preambles. The set of preambles may be shared with other UEs. Therefore, it is possible that the UE selects the same preamble as another UE, and both UEs may transmit their preambles at the same time, causing a collision or contention. The base station may apply a contention resolution mechanism to resolve the contention between two UEs.

A CBRA procedure may include the following steps. In step 1, the UE transmits a random access preamble. The preamble may be referred to as message 1 (MSG1) or random-access request. The random-access preamble may include a random-access preamble identifier.

In step 2, upon receiving the preamble, the base station may send a random-access response (RAR), also referred to as message 2 (MSG2). RAR may include the random-access preamble identifier, timing alignment information, initial uplink grant, and temporary cell (C)-radio network temporary identifier (RNTI).

After transmission of the preamble, the UE monitors the physical downlink control channel (PDCCH). The response is successful when the UE receives a response containing a random-access preamble identifier that is the same as the identifier contained in the transmitted random-access preamble.

In step 3, the UE sends uplink (UL) information, MSG3, over a physical uplink shared channel (PUSCH). The resources of the PUSCH may be granted by UL grant in MSG2.

After the UE sends MSG3, the UE monitors the PDCCH. The base station may send a contention resolution message, MSG4, to the UE. The contention resolution message may include information on PDCCH from which the UE obtains the C-RNTI or temporary C-RNTI.

The CBRA may also be referred to as a four-step random-access procedure or Type-1 PRACH.

In contention-free random access (CFRA), the base station may allocate the preamble to the UE. Such preamble may be referred to as a dedicated random-access preamble. The base station may provide the dedicated preamble to the UE through RRC signaling or physical layer signaling, e.g., downlink control information (DCI) on PDCCH. CFRA may be referred to as a two-step random-access procedure or Type-2 PRACH.

After the random-access preamble assignment, in step 1, the UE may transmit the assigned random-access preamble, MSG1. Upon receiving the random-access preamble, e.g., MSG1, the base station may send the random-access response, MSG2.

3GPP Technical Specifications (TSs) define reduced capability (RedCap) and small data transmission (SDT) features, among others. RedCap is a feature that reduces UE complexity by utilizing fewer transmit or receive antennas, reduced bandwidth, lower UE power consumption, relaxed data rates, or relaxed processing time. SDT is a feature that allows data or signaling transmission while the UE remains in an inactive state without transitioning to a connected state. For example, the UE may include a small amount of data in random-access messages.

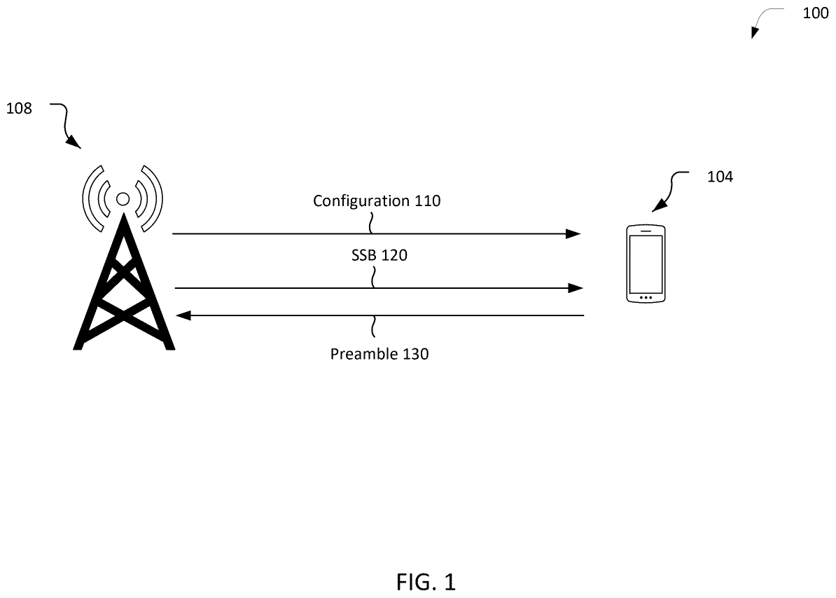

FIG. 1 illustrates a network environment 100 in accordance with some embodiments. The network environment 100 may include user equipment (UE) 104 communicatively coupled with base station 108 of a radio access network (RAN). The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The base station 108 may provide one or more cells, e.g., primary cell (PCell) or secondary cell (SCell). In some instances, a cell may be associated with a component carrier (CC). Each cell may be supported by multiple beams. Multiple beams may allow base station 108 to improve the coverage or throughput of the network by managing interference and concentrating the transmit power in a smaller geographic area. Each beam may be associated with a synchronization signal block (SSB) 120. The SSB 120 may include one or more reference signals or physical broadcast channel (PBCH). For example, SSB 120 may include a primary synchronization signal (PSS), a secondary synchronization signal (SSS), and PBCH. SSB 120 may be used for initial cell search, system frame number acquisition, or broadcast of essential system information. Configuration 110 may include configuration for one or more SSBs 120, including time and frequency resources and specific patterns, e.g., duration or periodicity of SSB 120 transmission.

For example, SSB 120 may occupy s/subcarriers, e.g., 240 subcarriers, in the frequency domain. SSB 120 may occupy s2 symbols, e.g., 4 symbols, in the time domain. SSB 120 may be transmitted periodically from each cell or each beam. For example, SSB 120 may have a periodicity s3, e.g., 20 ms. 3GPP TSs may define the frequency domain, time domain, or periodicity of the SSB 120. Multiple SSBs are sometimes transmitted in a sequence, e.g., for beam management. Transmission of multiple SSBs may be referred to as an SSB burst. Configuration 110 may provide a pattern or order of transmission of each SSB in an SSB burst. For example, SIB may include a parameter to determine the position of an SSB in an SSB burst, e.g., ssb-PositionInBurst, or RRC configuration may include configuration that is common for multiple UEs, e.g., ServingCellConfigCommon, which may configure SSBs, e.g., SSB indices, and SSB bursts, e.g., SSB burst patterns.

It is desirable to associate the random-access procedure with a beam, e.g., an SSB 120. In some instances, the time-frequency resources allocated for PRACH may be partitioned into disjoint subsets known as PRACH occasions, and configured SSBs may be mapped to PRACH occasions. In some instances, one SSB 120 may be mapped to one or more PRACH occasions. In another example, one or more SSBs 120 may be mapped to one PRACH occasion.

The UE 104 may receive configuration 110 from the base station 108. For example, during the initial access or RRC reconfiguration, the UE 104 may receive SIB, e.g., SIB 1. Configuration 110 may include one or more parameters to determine the time domain resources. For example, RRC dedicated PRACH configuration index, prach-ConfigurationIndex, or a time offset may determine the time slots or symbols allocated for the random-access procedure on PRACH. In some instances, the RRC may configure one or more time domain configurations, and the PRACH configuration index may determine one of the configurations.

Another parameter in configuration 110 may determine the frequency domain resources allocated for the random-access procedure. For example, RRC dedicated frequency offset, e.g., msg1-FrequencyStart, may determine the first subcarrier number allocated for the transmission of preamble 130. With the dedicated PRACH configuration index and the frequency offset parameters, the UE 108 may determine the time and frequency resources allocated for the transmission of preamble 130. The preamble 130 may be a sequence of symbols specified by 3GPP specifications or generated by the UE 104.

In some embodiments, configuration 110 may include a parameter indicating the number of SSBs associated with one PRACH occasion. Configuration 110 may include a parameter indicating the number of contention-based preambles per SSB index per valid PRACH occasion, e.g., RRC ssb-perRACH-OccasionAndCB-PreamblePerSSB. In one example, one-half (½) SSB index is associated with one PRACH occasion (RO), e.g., one SSB index is associated with 2 ROs. Each SSB index may be configured to correspond to 36 preambles on one valid RO.

In some embodiments, the SSB indices may be mapped to PRACH occasions in the following order: first, in increasing order of preamble indices within a single PRACH occasion; second, in increasing order of frequency resource indices for frequency-multiplexed PRACH occasions; third, in increasing order of time resource indices for time-multiplexed PRACH occasions within a PRACH slot; and fourth, in increasing order of indices for PRACH slots.

In some embodiments, the UE 104 may determine PRACH occasions for legacy UEs. Configuration 110 may configure additional or different PRACH occasions, e.g., for network energy saving (NES) UEs, in addition to PRACH occasions for legacy UEs. UE 104 may determine the additional PRACH occasions and may use both sets of PRACH occasions, e.g., the additional PRACH occasions and PRACH occasions for legacy UE.

In one embodiment, additional PRACH occasions may be configured using a general random-access channel (RACH) framework. In the general RACH framework, multiple RACH features may be configured, e.g., RedCap slicing or a combination of the features. Each feature configuration may include configuration for additional PRACH occasions. One or more features may initiate the PRACH procedure on the same PRACH occasion. In this case, a feature prioritization configuration in configuration 110 may determine which feature PRACH procedure may be performed.

In some embodiments, the PRACH occasions for the legacy UE may not overlap with the additional PRACH occasions. For example, base station 108 may configure them to avoid overlap.

In some embodiments, each set of PRACH occasions, e.g., the PRACH occasions for the legacy UE and the additional PRACH occasions, may have a separate SSB-to-PRACH occasion mapping. For example, configuration 110 may include one set of parameters to configure SSB-to-PRACH occasion mapping for the legacy UE and another set of parameters to configure SSB-to-PRACH occasion mapping for additional PRACH occasions.

In some embodiments, the additional PRACH occasions are a superset of the PRACH occasions for the legacy UEs.

In some embodiments, the additional PRACH occasions and the PRACH occasions for the legacy UE may overlap. The UE 104 may determine a set of PRACH occasions based on the additional set of PRACH occasions, and the PRACH occasions for the legacy UE. For example, the UE 104 may determine a set of PRACH occasions by removing the overlapping PRACH occasions from the additional set of PRACH occasions. In another embodiment, the UE 104 may determine the set of PRACH occasions to be the union of the additional PRACH occasions and the PRACH occasions for the legacy UE, e.g., containing both sets of PRACH occasions.

In some embodiments, the UE 104 computes the random-access (RA)-RNTI based on the additional PRACH occasions, the PRACH occasions for the legacy UE, or both. In some embodiments, the UE 104 may apply an offset in computing the RA-RNTI.

In some embodiments, the PRACH procedure may include the following steps. These steps may not be performed in the order they are presented here. Step 1, the UE 104 may select a carrier, e.g., a component carrier. For example, based on a comparison of reference signal receive power (RSRP) measurement of different carriers, the UE 104 may select the carrier. In some instances, when the RSRP of the normal uplink (NUL) carrier is smaller than a threshold, the UE 104 may select a supplementary uplink (SUL) carrier.

Step 2 may include selecting the set of random access resources applicable to the current scenario for random access procedure, e.g., initial access, RRC reconfiguration, cell reselection, etc. The random access resources may include the time-frequency resources and preambles. In some instances, each feature may be configured with a set of RACH resources. In some instances, the UE 104 may be configured by configuration 110 with different sets of preambles. Each set of preambles may have different sequences, each set having different symbols or sequence lengths. The selected set of resources may be used for both CFRA and CBRA. When multiple features are configured, the prioritization configuration determines the highest priority feature, and the RACH resources associated with the highest priority feature are selected.

Step 3 may include determining or selecting the random access type, e.g., two-step (CFRA) or four-step (CBRA) random-access. For example, if only two-step RACH resources are configured, CFRA is configured in reconfiguration with sync, or both are configured, and the measured RSRP is larger than a configured threshold for MSG1, then UE 104 may select and use two-step RACH. Otherwise, the UE 104 may select and perform four-step RACH.

Step 4 may include PRACH occasion selection or determination. For example, the UE 104 may select the PRACH occasions between the set of additional PRACH occasions or those for legacy UE. Alternatively or additionally, the UE 104 may determine the set of PRACH occasions as described in the examples and embodiments above.

Step 5 may include SSB selection. In some embodiments, the UE 104 may select SSB based on RSRP measurement associated with the SSB. In some embodiments, the UE 104 may select the SSB based on the number of PRACH resources mapped or associated with the SSB.

In step 6, the UE 104 may select the PRACH occasion from the selected or determined set of PRACH occasions. For example, the UE 104 may randomly select a PRACH occasion or prioritize additional PRACH occasions over PRACH occasions for legacy UEs.

In one embodiment, the set of additional PRACH occasions may be configured as a new RACH feature combination. The UE may maintain two (or more) sets of PRACH occasions; one is the set of PRACH occasions for legacy UE, and the other is the set of additional PRACH occasions. Alternatively, the UE may maintain only one set of PRACH occasions, which is obtained from the set of PRACH occasions for legacy UE and the set of additional PRACH occasions.

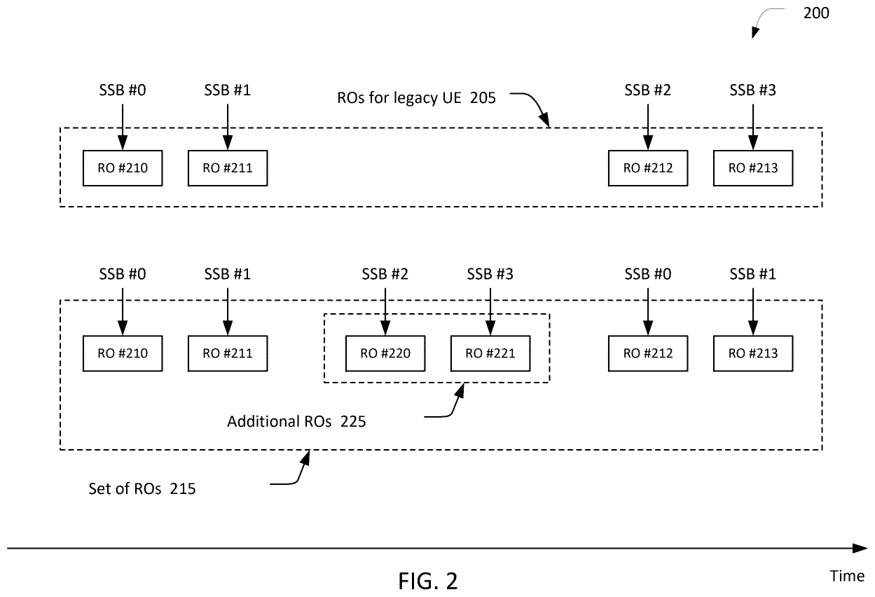

FIG. 2 illustrates a mapping 200 of synchronization signal block to PRACH occasions in accordance with some embodiments. Mapping 200 includes mapping SSBs, e.g., SSB #0-3, to PRACH occasions for legacy UE 205, e.g., RO #210-213. Mapping 200 also includes mapping SSBs, e.g., SSB #0-3, to a set of PRACH occasions 215, including both additional PRACH occasions 225, RO #220-221, and PRACH occasions for legacy UE 205, RO #210-213.

The UE 104 may use both PRACH occasions for the legacy UE 205 and additional PRACH occasions 225, e.g., the set of PRACH occasions 215. If the UE 104 uses the same mapping, it may cause ambiguity. For example, the mapping of 200 maps illustrates a configuration with 4 SSBs and a 1-to-1 mapping between SSBS and PRACH occasions, e.g., one SSB index is mapped to one PRACH occasion. When the UE 104 uses only PRACH occasions for the legacy UE, SSB #0 is mapped to PRACH occasion RO #210, SSB #1 is mapped to RO #211, SSB #2 is mapped to RO #212, and SSB #3 is mapped to RO #213. When the UE 104 uses both additional PRACH occasions 225 and the PRACH occasions for the legacy UE 205, e.g., the set of PRACH occasions 215, SSB #0 is mapped to RO #210, SSB #1 is mapped to RO #211, SSB #2 is mapped to RO #220, SSB #3 is mapped to RO #221, SSB #0 is mapped in the PRACH occasion to RO #212, and SSB #1 is mapped to RO #213. The mapping at RO #212 and #213 may be ambiguous. When UE 104 uses only PRACH occasions for legacy UE 205, SSB #2 is mapped to RO #212, and SSB #3 is mapped to RO #213. However, when the set of PRACH occasions 215 is used, SSB #0 is mapped to RO #212, and SSB #1 is mapped to RO #213.

It is desirable to configure the UE 104 to unambiguously utilize the configured PRACH occasions. Additionally or alternatively, the additional PRACH occasion 225 may be to change the density, SSB per PRACH occasion. Increasing the number of PRACH occasions that are associated with one SSB may reduce the probability of collision between transmission of preambles by different UEs.

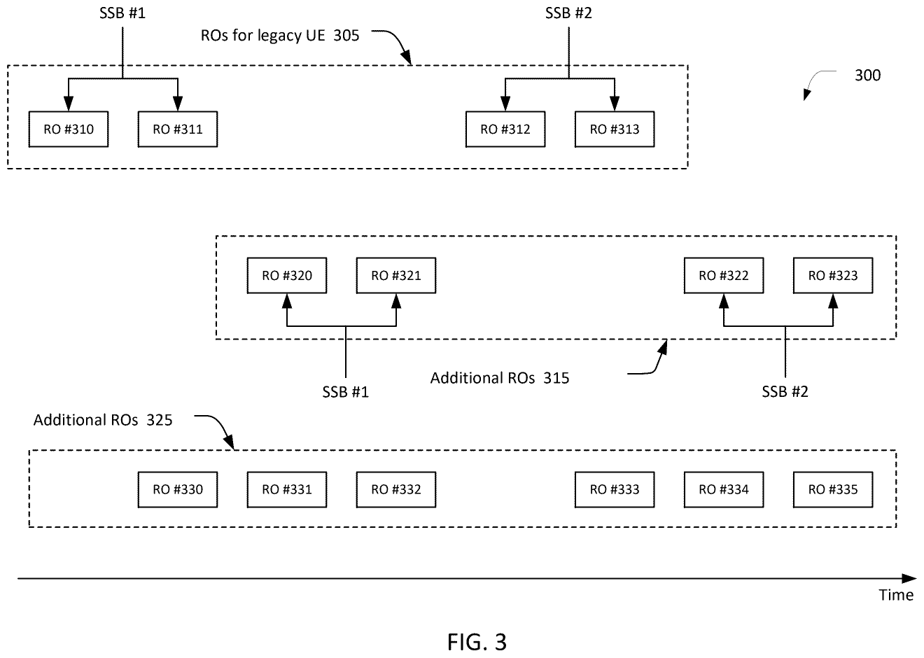

FIG. 3 illustrates another mapping 300 of synchronization signal block to PRACH occasions in accordance with some embodiments. Mapping 300 is an example of a configuration with two SSBs, SSB #1 and SSB #2, with a 1:2 mapping, e.g., one SSB is mapped to two PRACH occasions.

The base station 108 may configure the UE 104 with additional PRACH occasions 315, which does not overlap with the set of PRACH occasions for legacy UE 305. In some embodiments, base station 108 may separate the additional PRACH occasions 315 from the PRACH occasions for legacy UE 305 in the time domain to ensure they do not overlap. For example, the additional PRACH occasions 315 may have a dedicated time domain configuration, e.g., RRC prach-ConfigurationIndex, or a dedicated time offset, and the PRACH occasions for the legacy UE 305 may have a different and dedicated time domain configuration, e.g., RRC prach-ConfigurationIndex, or a dedicated time offset. By selecting the time domain parameters for additional PRACH occasions 315 and PRACH occasions for legacy UE 305, the base station 108 may separate them in the time domain and non-overlapping.

In some embodiments, base station 108 may separate the additional PRACH occasions 315 from the PRACH occasions for legacy UE 305 in the frequency domain to ensure they do not overlap. For example, the additional PRACH occasions 315 may have a dedicated frequency domain configuration, e.g., RRC msg1-FrequencyStart, or a dedicated frequency offset, and the PRACH occasions for the legacy UE 305 may have a different and dedicated frequency domain configuration, e.g., RRC msg1-FrequencyStart, or a dedicated frequency offset. By selecting the frequency domain parameters for additional PRACH occasions 315 and PRACH occasions for legacy UE 305, base station 108 may separate them in the frequency domain and non-overlapping.

In some embodiments, the base station 108 may configure the UE 104 with a list of dedicated PRACH occasions, where each PRACH occasion in the list is configured with time and frequency resources that do not overlap with the PRACH occasions for the legacy UE.

In some embodiments, the base station 108 may configure the UE 104 with dedicated SSB-to-PRACH occasions mapping for additional PRACH occasions and another SSB-to-PRACH occasions mapping for the PRACH occasions for legacy UEs. In some instances, the configuration may be an RRC information element (IE), e.g., RRC IE ssb-perRACH-OccasionAndCB-PreamblesPerSSB. In some instances, the base station 108 may configure with a list of {SSB index, a list of associated PRACH occasions, or preambles}, which may achieve an uneven RO distribution among SSBs. The list of PRACH occasions may only include additional PRACH occasions, PRACH occasions for the legacy UE, or PRACH occasions from the set of additional PRACH occasions and the set of PRACH occasions for legacy UE. The UE 104 may use the configured dedicated mapping to map the PRACH occasions to SSBs.

The dedicated SSB-to-PRACH occasions mapping may resolve the mapping ambiguity, and the UE 104 may not need to check the SSB-to-PRACH occasions mapping because the base station 108 has ensured non-overlapping resources and an SSB may be mapped to an additional PRACH occasion can only by the associated dedicated SSB-to-PRACH occasion mapping.

The mapping 300 is an example of non-overlapping PRACH occasions between the PRACH occasions for legacy UE 305 and additional PRACH occasions 315. The SSB #1 is mapped to RO #310 and RO #311 based on configurations for the PRACH occasions for legacy UEs. Similarly, SSB #1 is mapped to RO #320 and RO #321 based on the configurations for additional PRACH occasions. The SSB #s is mapped to RO #312 and RO #313 based on the PRACH occasions configurations for legacy UEs, and SSB #2 is mapped to RO #322 and RO #323 based on the configurations for additional PRACH occasions.

In one example (not depicted), the UE 104 may be configured with a 1:1 SSB-to-PRACH occasion mapping for the set of PRACH occasions for legacy UE while the SS-to-PRACH occasion mapping for the set of additional PRACH occasions 315 remains 1:2. With that configuration, SSB #1 is mapped to RO #310 and SSB #2 to RO #311 based on configurations for the PRACH occasions for legacy UEs, SSB #1 is mapped to RO #320 and RO #321 based on the configurations for additional PRACH occasions, SSB #1 is mapped to RO #312 and SSB #2 to RO #313 based on configurations for the PRACH occasions for legacy UEs, and SSB #2 is mapped to RO #320 and RO #321 based on the configurations for additional PRACH occasions. By changing the mapping configuration, base station 108 could configure different SSB-to-PRACH occasion densities for the set of PRACH occasions for legacy UEs and additional PRACH occasions.

In some embodiments, the set of additional PRACH occasions 325 may partially overlap with the set of PRACH occasions for the legacy UE 305. For example, RO #330 and RO #333 of the set of additional PRACH occasions 325 overlap with RO #311 and RO #313 of the set of PRACH occasions for legacy UE 305, respectively. The UE 104 may generate the set of additional PRACH occasions 315 from the set of additional PRACH occasions 325 by removing the overlapping or duplicated PRACH occasions and re-indexing the remaining PRACH occasions.

In some embodiments, the UE 104 may re-index the PRACH occasion, starting with a PRACH occasion having the smallest slot index (e.g., slot number), smallest time resource index, and the smallest frequency resource index. The UE 104 may assign the smallest index, e.g., 0, to this PRACH occasion. The UE 104 may assign subsequent indices to PRACH occasions with the same slot index and time resource index and in increasing order of frequency resource index. Once all of the PRACH occasions in this group are re-indexed, the UE 104 may find the PRACH occasions with the next smallest time resource index. Again, the UE 104 may re-index the PRACH occasion in the increasing order of frequency resources. Finally, once the UE 104 re-indexed all the PRACH occasions in the time slot, the UE 104 may move to re-index the PRACH occasions in the subsequent time slots.

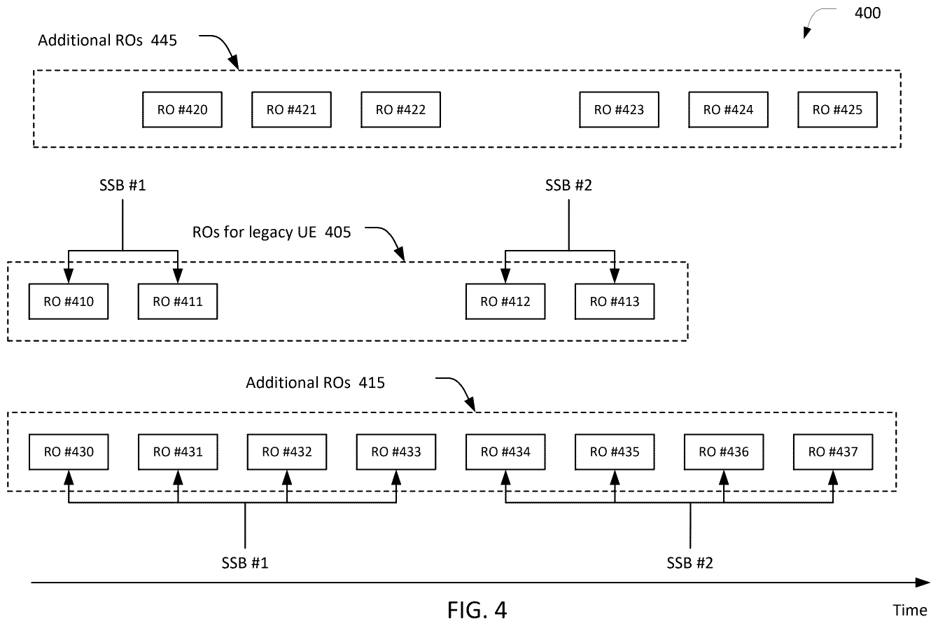

FIG. 4 illustrates another mapping 400 of synchronization signal block to PRACH occasions in accordance with some embodiments. Mapping 400 is an example of a configuration with two SSBs, SSB #1 and SSB #2, with a 1:2 SSB-to-PRACH occasion mapping for PRACH occasions for legacy UE 405, e.g., one SSB is mapped to two PRACH occasions, and a 1:4 SSB-to-PRACH occasion mapping for the additional PRACH occasions 415, e.g., one SSB is mapped to four PRACH occasions.

In some embodiments, the base station 108 may configure the UE 104 with PRACH occasions for legacy UE 405 and additional PRACH occasions 415. The base station 108 may include the PRACH occasions for legacy UE 405 in the additional PRACH occasions 415, e.g., the additional PRACH occasions 415 is a superset of PRACH occasions for legacy UE 405.

The UE 104 may be configured with a 1:2 SSB-to-PRACH mapping for the set of PRCH occasions for legacy UE 405. SSB #1 is mapped to PRACH occasions RO #410 and RO #411, and SSB #2 is mapped to PRACH occasions RO #412 and RO #413. The UE 104 may be configured with a 1:4 SSB-to-PRACH mapping for the set of additional PRACH occasions 415. SSB #1 is mapped to PRACH occasions RO #430, RO #431, RO #432, and RO #433, and SSB #2 is mapped to PRACH occasions RO #434, RO #435, RO #436 and RO #437.

In some embodiments, the UE 104 may derive a single set, including the set of PRACH occasions for legacy UE and additional PRACH occasions. For example, the UE 104 may be configured with the set of additional PRACH occasions 445 and the set of PRACH occasions for the legacy UE 405. The UE 104 may generate the set 415 by combining, e.g., taking the union of the set of additional PRACH occasions 445 and the set of PRACH occasions for the legacy UE 405 and re-indexing the PRACH occasions.

In some embodiment, the UE 104 may calculate the RA-RNTI based on one or more parameters associated with the PRACH occasion used for transmission of the preamble. For example, the formula for calculating RA-RNTI may be RA-RNTI=1+s_id+14×t_id+14×80×f_id+14×80×8×ul_carrier_id, where s_id is the symbol index, t_id is the time domain index, f_id is the frequency domain index, and ul_carrier_id is the carrier index of the PRACH occasion used for the preamble transmission.

Assume that PRACH occasions for legacy UE 405 are indexed as RO #410 has index 0, RO #411 has index 1, and the indices repeat, e.g., RO #412 has index 0, and RO #413 has index 1. Additional PRACH occasions 415 may be indexed as RO #430 has index 0, RO #431 has index 1, RO #432 has index 2, and RO #432 has index 3. Further, RO #412 and RO #434 overlap. When calculating the RA-RNTI, there is an ambiguity as the RO #412 and RO #434 may have different indices, e.g., different s_id, t_id, or f_id, causing to calculate two different RA-RNTI based on whether using the indexing associated with the additional PRACH occasions 415 or PRACH occasions for legacy UE 405.

In some embodiments, to resolve the ambiguity in calculating the RA-RNTI, the UE 104 may use the index associated with the set of PRACH occasions for legacy UE 405. For example, when the PRACH occasion overlaps between the set of additional PRACH occasions 415 and the set of PRACH occasions for legacy UE 405, the UE may use the index of the PRACH occasions associated with the set of PRACH occasions of legacy UE 405.

In another embodiment, the UE 104 may use an offset to resolve the ambiguity. For example, when a PRACH occasion is associated with a different set of indices, resulting in ambiguity in calculating RA-RNTI, the UE 104 may use an offset in the RA-RNTI formula. The UE 104 may calculate the RA-RNTI as RA-RNTI=1+s_id+14×t_id+14×80×f_id+14×80×8×ul_carrier_id+Offset, where Offset=14×80×8×3. The Offset may resolve the ambiguity between calculating RA-RNTI using the indices associated with the PRACH occasion in the set of PRACH occasions for legacy UE or the PRACH occasion in the set of additional PRACH occasions.

In some embodiments, the base station 108 may configure the UE 104 with a set of additional PRACH resources that is a superset of the PRACH resources for legacy UE, e.g., includes the PRACH occasions for the legacy UE. Once the UE 104 selects which set of PRACH occasions to use, the dedicated mapping associated with that set may resolve any ambiguity.

With the introduction of additional PRACH occasions and associated configurations, e.g., dedicated SSB-to-PRACH occasion mapping, each SSB may be associated with a different number of PRACH occasions. UE 104 may utilize the un-even PRACH occasion distribution among SSBs in SSB selection.

In one embodiment, the UE may first calculate the total number of valid PRACH occasions for each SSB. The total number of valid PRACH occasions may be obtained as the sum of the number of PRACH occasions for legacy UE associated with the SSB (e.g., SSB index) and the number of additional PRACH occasions associated with the SSB.

In some embodiments, the UE 104 may calculate or determine a first total number of PRACH occasions for a first SSB. The UE 104 may calculate or determine a second total number of PRACH occasions for a second SSB. The UE 104 may determine that the first total number of PRACH occasions is greater than the second total number of PRACH occasions. The UE 104 may prioritize the first SSB over the second SSB based on the determination that the first total number of PRACH occasions is greater than the second total number of PRACH occasions.

In some embodiments, the UE 104 may determine a first RSRP associated with the first SSB and a second RSRP associated with the second SSB. In a first alternative, the UE 104 may prioritize the first SSB over the second SSB based on the determination that the first total number of PRACH occasions is greater than the second total number of PRACH occasions when at least one of the first RSRP or the second RSRP is larger than a first threshold. In another instance, the UE 104 may prioritize the first SSB over the second SSB based on the determination that the first total number of PRACH occasions is greater than the second total number of PRACH occasions when the first RSRP and the second RSRP is not larger than a second threshold. The first or second thresholds may be specified by 3GPP specifications or may be configured by the base station 108, e.g., via RRC signaling.

In some embodiment, the UE 104 may calculate or determine a first number of additional PRACH occasions associated with a first SSB. The UE 104 may calculate or determine a second number of additional PRACH occasions associated with a second SSB. The UE 104 may determine that the first total number of additional PRACH occasions is greater than the second number of additional PRACH occasions. In a second alternative, the UE 104 may prioritize the first SSB over the second SSB based on the determination that the first number of additional PRACH occasions is greater than the second number of additional PRACH occasions.

In some embodiment, the UE 104 may first apply prioritization based on the number of additional PRACH occasions, e.g., the second alternative. If two SSBs have the same number of additional PRACH occasions, the UE 104 may apply prioritization based on the total number of PRACH occasions. UE 104 may apply selection or prioritization based on RSRP measurement as described above.

In some embodiments, the UE may determine whether the RSRP of the first SSB or the RSRP of the second SSB is larger than a threshold. Based on the determination that at least the RSRP of one of the SSBs is greater than the threshold, in a third alternative, the UE 104 may apply the first alternative, the second alternative, or a combination of both to prioritize and select an SSB.

In some embodiments, the UE 104 may determine the RSRP difference between the larger and the smaller RSRP of the first RSRP of the first SSB and the second RSRP of the second SSB. The UE 104, in a fourth prioritization alternative, may apply the first alternative prioritization, the second alternative prioritization, or the combination of the first and second alternatives when the RSRP difference is larger than a variance threshold. The variance threshold may be specified by 3GPP specifications or may be configured by the base station 108, e.g., via RRC signaling.

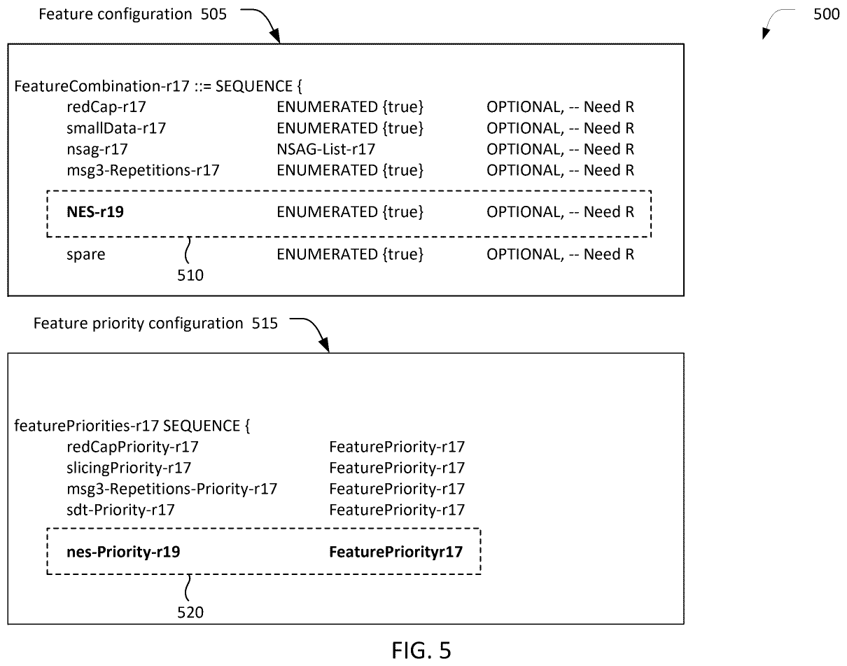

FIG. 5 illustrates an example of configurations 500 in accordance with some embodiments. Configurations 500 may include a feature configuration 505. The feature configuration 505 may include one or more configurations respectively associated with one or more features, e.g., RedCap, small data transmission (SDT), or NES 510. The UE 104 may derive the PRACH occasions from the NES-r19 510 configuration.

In some instances, the schedule for transmission of the preamble of one feature may coincide or collide with the schedule for transmission of the preamble of another feature. Feature priority configuration 515 may configure an order or priority for each feature. For example, the priority of the PRACH procedure on the additional PRACH resources may be determined by NES-priority-r19 520.

In some embodiments, the UE 104 may maintain one set of PRACH occasions. The UE 104 may derive the set of PRACH occasions to be the set of additional PRACH occasions, the set of additional PRACH occasions without the duplicated or overlapping PRACH occasions with the set of PRACH occasions for legacy UE, or the union of the set of additional PRACH occasions and the set of PRACH occasions for the legacy UE.

In some embodiments, the UE 104 may maintain two sets of PRACH occasions; one is the set of PRACH occasions for the legacy UE, and the other is the set of additional PRACH occasions.

When the UE 104 maintains two sets of PRACH occasions, the UE 104 may apply a set selection procedure before PRACH occasion selection. With the set selection, the UE 104 selects between the set of PRACH occasions for legacy UE and the set of additional PRACH occasions.

In some embodiment, the UE 104 may select randomly between the set of PRACH occasions for legacy UE and the set of additional PRACH occasions. The UE 104 may select between the two sets with equal probability or may apply a bias, e.g., to make it more likely to select one set, e.g., the set of additional PRACH occasions, over the other. In some instances, the base station 108 may configure the probabilities, e.g., via RRC signaling. For example, the base station 108 may configure the UE 104 to randomly select the set of additional PRACH occasions with probability P (e.g., randomly select the set of PRACH occasions for legacy UE with probability 1-P). The probability P may be configured by RRC signaling, for example.

In one embodiment, the UE 104 may follow the feature priority determined by feature priority configuration 515. For example, if the PRACH occasions for legacy UE are configured with the redCap-r17 of feature configuration 505 and the additional PRACH occasions are configured with the NES-r19 510, then the prioritization between the two sets may follow the configured priorities for redCapPriority-r17 and nes-priority-r19 510 of the feature priority configuration 515.

In some embodiments, the UE may prioritize the set of additional PRACH occasions over the set of PRACH occasions for legacy UE.

In some embodiments, in case of overlapped resources, either legacy or additional PRACH resources are selected.

In some embodiments, the UE 104 may prioritize the resource earlier in the time domain. For example, at time slot n, the UE 104 may prioritize the PRACH occasions that are allocated at slot n+t1 over the PRACH occasion that is allocated at slot n+t2 when t1 is less than t2, e.g., it is earlier in the time domain.

In some embodiments, there are two alternatives for the retransmission of the preamble. In the first alternative, the UE 104 may perform a set selection for each transmission or retransmission, e.g., the set of PRACH occasions of retransmission may be different from the set of PRACH occasions for the initial transmission. In the second alternative, the UE 104 may select the same set as the initial preamble transmission for the preamble retransmission. For example, suppose the initial preamble transmission was performed on a PRACH occasion of the set of additional PRACH occasions. In that case, the retransmission of the preamble will also use a PRACH occasion of the same set.

In some embodiments, instead of selecting a set, the UE 104 may derive the union of the set of PRACH occasions for legacy UE and the set of the additional PRACH occasions for the selected SSB.

In some embodiments, section 5.1.2 of 3GPP TS 38.321 v.18.1.0 2024 Apr. 4 may be amended, as shown below, with the underlined text added to account for contention-based random access preamble selection in accordance with some embodiments:
1> if additional random access resource is configured,
   2> The UE calculates the total number of valid PRACH resources, including the number of additional PRACH resources, for each SSB:
1> if at least one of the SSBs with synchronization signal (SS)-RSRP above a rsrpThresholdSSB is available:
   2> if additional random access resource is configured
      3> select an SSB with SS-RSRP above rsrp-ThresholdSSB and the largest number of total PRACH resources.
   2> else:
      3> select an SSB with SS-RSRP above rsrp-ThresholdSSB
1> else:
   2> if additional random access resource is configured
      3> select an SSB with the largest number of total PRACH resources.
   2> else:
      3> select any SSB

In some embodiments, for two PRACH resource sets derivation (PRACH resource set may be referred to as the set of PRACH occasions), the medium access control (MAC) entity may:
1> among the available sets of random access resources for this random access procedure (as specified in clause 5.1.1c of the 3GPP TS 38.321, identify those configured with a feature which has the highest priority assigned in featurePriorities among all the features applicable to this random access procedure as specified in the 3GPP TS 38.331 v.18.1.0 2024 Apr. 1
1> if a single set of random access resources is identified:
   2> select this set of random access resources.
1> else if more than one set of random access resources is identified:
   2> if one identified set of random access resources is configured as NES:
      3> select the set of random access resources
      3> for the remaining identified set(s) of random access resources, repeat the procedure taking as an input the identified sets of random access resources and the feature applicable to the current random access procedure with the highest priority assigned in featurePriorities among all the features applicable to this random access procedure, except the features considered already.
   2> else
      3> repeat the procedure taking as an input the identified sets of random access resources and the feature applicable to the current random access procedure with the highest priority assigned in feature Priorities among all the features applicable to this random access procedure, except the features considered already.
1> else (i.e., no set of random access resources is identified):
   2> repeat the procedure taking as an input the previously identified available sets of random access resources and the feature applicable to the current random access procedure with the highest priority assigned in feature Priorities among all the features applicable to this random access procedure, except the features considered already.

In some embodiments, PRACH occasion selection may include:
1> else if an SSB is selected above:
   2> if additional set of random access resources is associated with the selected SSB:
      3> select between additional set of PRACH resource and the other set of PRACH resource randomly with equal probability:
      3> determine the next available PRACH occasion from the PRACH occasions corresponding to the selected SSB permitted by the restrictions given by the ra-ssb-OccasionMaskIndex if configured, or ssb-SharedRO-MaskIndex if configured, or indicated by PDCCH (the MAC entity shall select a PRACH occasion randomly with equal probability amongst the consecutive PRACH occasions according to clause 8.1 of the 3GPP TS 38.213 v.18.2.0 2024 Mar. 29 regardless the FR2 UL gap, corresponding to the selected SSB; the MAC entity may take into account the possible occurrence of measurement gaps and MUSIM gaps when determining the next available PRACH occasion corresponding to the selected SSB).
   2> else:
      3> determine the next available PRACH occasion from the PRACH occasions corresponding to the selected SSB permitted by the restrictions given by the ra-ssb-OccasionMaskIndex if configured, or ssb-SharedRO-MaskIndex if configured, or indicated by PDCCH (the MAC entity shall select a PRACH occasion randomly with equal probability amongst the consecutive PRACH occasions according to clause 8.1 of TS 38.213 regardless the FR2 UL gap, corresponding to the selected SSB; the MAC entity may take into account the possible occurrence of measurement gaps and MUSIM gaps when determining the next available PRACH occasion corresponding to the selected SSB).

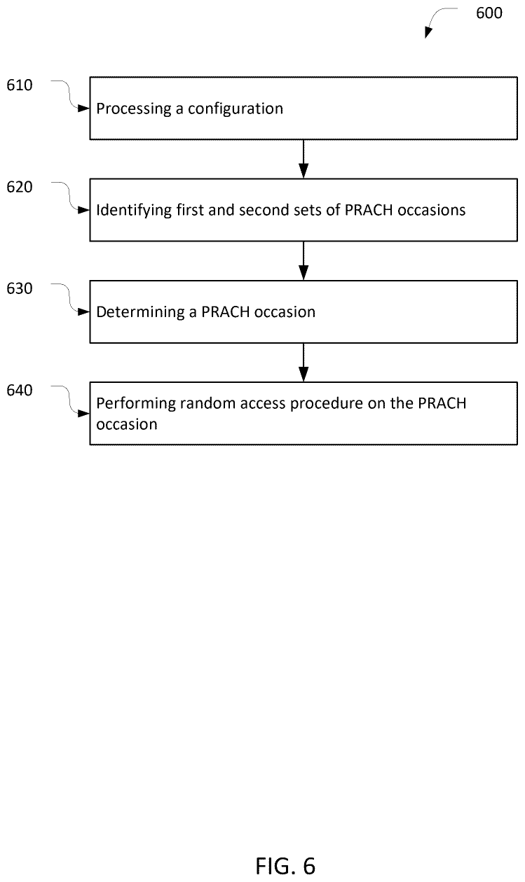

FIG. 6 illustrates an operation flow/algorithmic structure 600 in accordance with some embodiments. The operation flow/algorithmic structure 600 may be performed or implemented by a UE such as, for example, the UE 104 or UE 800; or components thereof, for example, baseband processor circuitry 804A.

The operation flow/algorithmic structure 600 may include, at 610, processing configuration. The configuration may be associated with a random access procedure. The configuration may be RRC configuration. The UE 104 may receive and process SIB, e.g., SIB 1, containing configuration associated with the random access procedure.

The operation flow/algorithmic structure 600 may include, at 620, identifying a first and second sets of PRACH occasions. The first set of PRACH occasions may be defined with respect to the second set of PRACH occasions. The second set of PRACH occasions may be configured for legacy UEs.

In some embodiments, the first set of PRACH occasions, e.g., the set of additional PRACH occasions, may not overlap the second set of PRACH occasions, may partially overlap the second set of PRACH occasions, or may be a superset of the second set of PRACH occasions.

In some embodiments, the first set of PRACH occasions may not overlap with the second set of PRACH occasions. The first set of PRACH occasions may be separated from the second set of PRACH occasions in a time domain. For example, a PRACH configuration index (prach-ConfigurationIndex) and a time offset may configure the first set of PRACH occasions to be separated from the second set of PRACH occasions in the time domain.

In some embodiments, the first set of PRACH occasions may be separated from the second set of PRACH occasions in a frequency domain. For example, the configuration may include a frequency offset for the first set of PRACH occasions to separate the first set of PRACH occasions from the second set of PRACH occasions.

In some embodiments, each PRACH occasion of the first set of PRACH occasions may be configured with individual time and frequency locations that do not overlap with the second set of PRACH occasions.

In some embodiments, the configuration is to configure the first set of PRACH occasions with a first SSB-to-PRACH occasion mapping. The configuration may configure the second set of PRACH occasions with a second SSB-to-PRACh occasion mapping, which may be different from the first SSB-to-PRACH occasions mapping. In some embodiments, the SSB-to-PRACH occasions mapping may comprise a list of one or more SSB indices that are respectively associated with one or more PRACH occasions.

In some embodiments, the first set of PRACH occasions may partially overlap the second set of PRACH occasions. The UE 104 may determine a third set of PRACH occasions based on the first and second sets of PRACH occasions. The UE 104 may determine the third set of PRACH occasions by taking the PRACH occasions of the first set of PRACH occasions that do not overlap with the second set of PRACH occasions and adding them to the third set of PRACH occasions. In some embodiments, the third set of PRACH occasions is the union of the first set and the second set of the PRACH occasions.

In some embodiment, the UE 104 may re-index the PRACH occasions in the third set of PRACH occasions. The UE 104 may first re-index PRACH occasions from increasing order of frequency resource indices, then from increasing order of time resource indices, and finally in increasing order of indices for PRACH slots. In some instances, the time resource index may be the symbol number within a slot. In some instances, the frequency resource index may be the subcarrier index.

In some embodiments, the first set of PRACH occasions may partially overlap the second set of PRACH occasions. The UE 104 may compute the RA-RNTI based on a PRACH occasion of the second set of PRACH occasions. In some embodiments, the UE 104 may compute the RA-RNTI based on an offset.

In some embodiments, the UE 104 may determine a total number of PRACH occasions associated with each configured or activated SSB. The UE 104 may prioritize one SSB over another based on their respective total number of PRACH occasions. The UE 104 may prioritize the SSB over the other when at least one RSRP associated with one of the SSBs is larger than a threshold. The threshold may be configured by the base station 108, e.g., via RRC signaling, or it may be specified by the 3GPP specifications.

In some embodiments, the UE 104 may determine a difference between the RSRP of a first SSB and that of a second SSB. The UE 104 may apply prioritization based on a total number of PRACH occasions associated with the SSBS when the difference between the RSRPs is larger than a threshold. The base station 108 may configure the threshold, e.g., via RRC signaling, or it may be specified by the 3GPP specifications.

In some embodiments, the UE 104 may prioritize a first SSB over a second SSB based on a number of PRACH occasions of the first set of PRACH occasions associated with the first SSB and a number of PRACH occasions of the first set of PRACH occasions associated with the second SSB. The UE 104 may prioritize the first SSB over the second SSB based on determining that the first number of PRACH occasions of the first set of PRACH occasions associated with a first SSB is greater than the second number of PRACH occasions of the second set of PRACH occasions associated with a second SSB.

The operation flow/algorithmic structure 600 may include, at 630, determining a PRACH occasion. In some embodiments, the UE 105 may randomly select a set between the first set of PRACH occasions and the second set of PRACH occasions. The UE 104 may then randomly select the PRACH occasion from the selected set of PRACH occasions.

In some embodiments, the UE 104 may select the set of PRACH occasions based on a priority order. The priority order may be determined based on a configured priority of a feature associated with the set of PRACH occasions.

In some embodiments, the UE 104 may select the PRACH occasion that occurred earlier in the time domain.

The operation flow/algorithmic structure 600 may include, at 640, performing the random access procedure on the PRACH occasion. Once the PRACH occasion is determined, the UE 104 may initiate performing the random access procedure by generating and transmitting a preamble on the selected PRACH occasion.

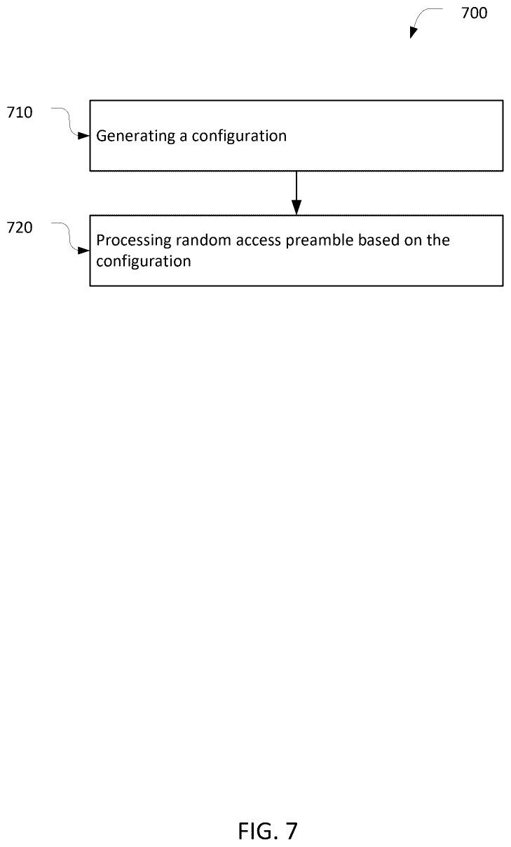

FIG. 7 illustrates an operational flow/algorithmic structure 700 in accordance with some embodiments. The operation flow/algorithmic structure 700 may be performed or implemented by a base station such as, for example, the base station 108 or the base station 900; or components thereof, for example, baseband processor circuitry 904A.

The operation flow/algorithmic structure 700 may include, at 710, generating a configuration. The configuration may include a first set of parameters associated with a first set of PRACH occasions. The first set of PRACH occasions may be defined with respect to a second set of PRACH occasions configured for legacy UEs. The configuration may include the second set of parameters associated with the second set of PRACH occasions configured for legacy UEs.

In some embodiments, the configuration may include a first configuration to map SSBs to the first set of PRACH occasions. The configuration may include a second configuration to map SSBs to the second set of PRACH occasions.

The configuration may separate the first set of PRACH occasions from the second set of PRACH occasions in the time or frequency domain.

The operation flow/algorithmic structure 700 may include, at 720, processing a random access preamble based on the configuration. Base station 108 may receive a preamble of a PRACH procedure associated with an SSB based on the configuration provided by base station 108.

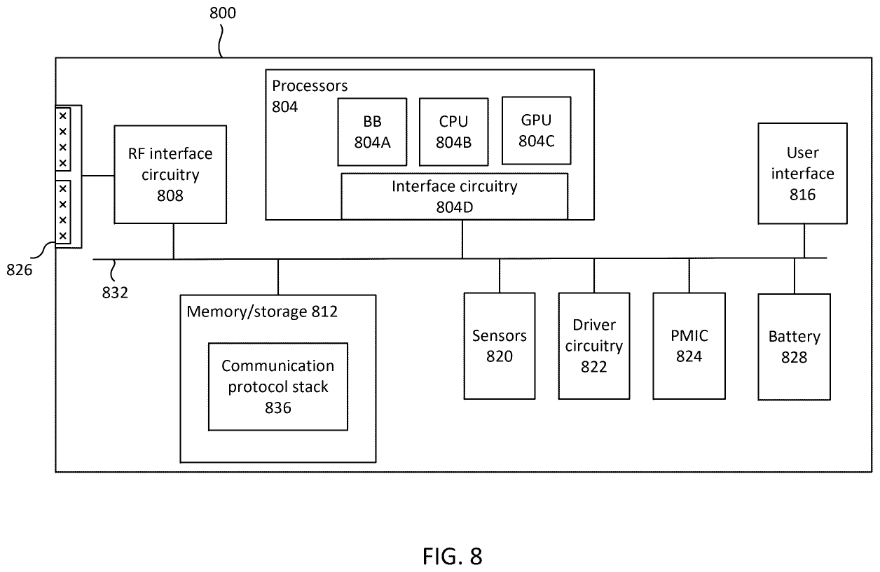

FIG. 8 illustrates a UE 800 in accordance with some embodiments. The UE 800 may be similar to and substantially interchangeable with the UE 104.

The UE 800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 800 may include processors 804, RF interface circuitry 808, memory/storage 812, user interface 816, sensors 820, driver circuitry 822, power management integrated circuit (PMIC) 824, antenna 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangements of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein. The processors 804 may also include interface circuitry 804D to communicatively couple the processor circuitry with one or more other components of the UE 800.

In some embodiments, the baseband processor circuitry 804A may access a communication protocol stack 836 in the memory/storage 812 to communicate over a 3GPP-compatible network. In general, the baseband processor circuitry 804A may access the communication protocol stack 836 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 812 may include one or more non-transitory, computer-readable media that include instructions (for example, communication protocol stack 836) that may be executed by one or more of the processors 804 to cause the UE 800 to perform various operations described herein.

The memory/storage 812 includes any type of volatile or non-volatile memory that may be distributed throughout the UE 800. In some embodiments, some of the memory/storage 812 may be located on the processors 804 themselves (for example, memory/storage 812 may be part of a chipset that corresponds to the baseband processor circuitry 804A), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 808 may include transceiver circuitry and a radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple input, multiple output communications. The antenna 826 may include microstrip antennas, printed antennas fabricated on the surface of one or more printed circuit boards, patch antennas, or phased array antennas. The antenna 826 may have one or more panels designed for specific frequency bands, including bands in FRI or FR2.

The user interface 816 includes various input/output (I/O) devices designed to enable user interaction with the UE 800. The user interface 816 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within or connected to the UE 800. For example, driver circuitry 822 may include a display driver to control and allow access to a display device, a touchscreen driver to control and allow access to a touchscreen interface, sensor drivers to obtain sensor readings of sensors 820, and control and allow access to sensors 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

A battery 828 may power the UE 800, although in some examples, the UE 800 may be mounted deployed in a fixed location and may have a power supply coupled to an electrical grid. The battery 828 may be a lithium-ion battery, a metal-air battery, such as a zinc-air battery, an aluminum-air battery, a lithium-air battery, and the like. In some implementations, such as in vehicle-based applications, the battery 828 may be a typical lead-acid automotive battery.

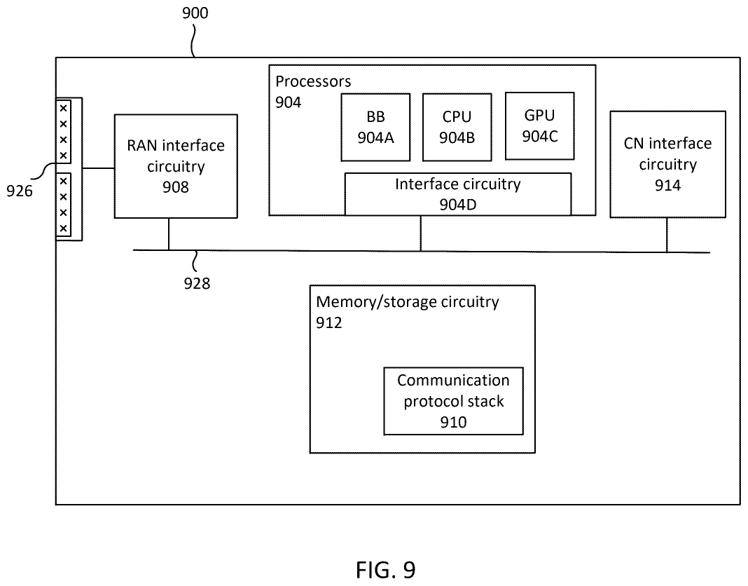

FIG. 9 illustrates a network device 900 in accordance with some embodiments. The network device 900 may be similar to and substantially interchangeable with base station 108.

The network device 900 may include processors 904, RF interface circuitry 908 (if implemented as a base station), core network (CN) interface circuitry 914, memory/storage circuitry 912, and antenna structure 926.

The components of the network device 900 may be coupled with various other components over one or more interconnects 928.

The processors 904, RF interface circuitry 908, memory/storage circuitry 912 (including communication protocol stack 910), antenna structure 926, and interconnects 928 may be similar to like-named elements shown and described with respect to FIG. 8.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage circuitry 912 to cause the UE 800 to perform operations as described herein. The processors 904 may also include interface circuitry 904D to communicatively couple the processor circuitry with one or more other components of the network device 900.

The CN interface circuitry 914 may provide connectivity to a core network, for example, a 5th Generation Core network (5GC) using a 5GC-compatible network interface protocol such as carrier Ethernet protocols or some other suitable protocol. Network connectivity may be provided to/from the network device 900 via a fiber optic or wireless backhaul. The CN interface circuitry 914 may include one or more dedicated processors or FPGAs to communicate using one or more of the aforementioned protocols. In some implementations, the CN interface circuitry 914 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### Examples

In the following sections, further exemplary embodiments are provided.

Example 1 includes a method including: processing a configuration associated with a random access procedure; identifying, based on the configuration, a first set of physical random access channel (PRACH) occasions defined with respect to a second set of PRACH occasions configured for legacy user equipments (UEs), wherein the first set of PRACH occasions: do not overlap the second set of PRACH occasions; partially overlap the second set of PRACH occasions; or are a superset of the second set of PRACH occasions; determining a PRACH occasion based on the first set of PRACH occasions; and performing the random access procedure on PRACH occasion.

Example 2 includes the method of example 1 or some other examples herein, further including: wherein the first set of PRACH occasions do not overlap with the second set of PRACH occasions.

Example 3 includes the method of examples 1 or 2 or some other example herein, wherein the first set of PRACH occasions are separated from the second set of PRACH occasions in a time domain.

Example 4 includes the method of any of examples 1-3 or some other example herein, wherein the configuration includes a physical random access channel, configuration index (prach-ConfigurationIndex) and a time offset for the first set of PRACH occasions.

Example 5 includes the method of any of examples 1-3 or some other example herein, wherein the first set of PRACH occasions are separated from the second set of PRACH occasions in a frequency domain.

Example 5 includes the method of any of examples 1˜4 or some other example herein, wherein the configuration includes a include a frequency offset for the first set of PRACH occasions.

Example 6 includes the method of any of examples 1-5 or some other example herein, wherein the configuration is to configure individual PRACH occasions of the first set of PRACH occasions with individual time and frequency locations that do not overlap with the second set of PRACH occasions.

Example 7 includes the method of any of examples 1-6 or some other example herein, wherein the configuration is to configure the first set of PRACH occasions with a first synchronization signal block (SSB)-to-PRACH occasions mapping that is different from a second SSB-to-PRACH occasions mapping associated with the second set of PRACH occasions.

Example 9 includes the method of any of examples 1-8 or some other example herein, wherein the first SSB-to-PRACH occasions mappings include a list of one or more SSB indices that are respectively associated with one or more PRACH occasions.

Example 10 includes the method of any of examples 1-9 or some other example herein, wherein the first set of PRACH occasions is a superset of the second set of PRACH occasions.

Example 11 includes the method of any of examples 1-10 or some other example herein, wherein the first set of PRACH occasions partially overlaps the second set of PRACH occasions and the method further including: determining a third set of PRACH occasions based on the first set of PRACH occasions and the second set of PRACH occasions, wherein said determining the PRACH occasion further includes: selecting the PRACH occasion from the third set of PRACH occasions.

Example 12 includes the method of any of examples 1-11 or some other example herein, wherein said determining the third set of PRACH occasions includes: determining that the third set of PRACH occasions includes PRACH occasions of the first set of PRACH occasions that do not overlap with the second set of PRACH occasions.

Example 13 includes the method of any of examples 1-12 or some other example herein, wherein said determining the third set of PRACH occasions includes: determining that the third set of PRACH occasions includes PRACH occasions of the first set of PRACH occasions that overlap with the second set of PRACH occasions overlap.

Example 14 includes the method of any of examples 1-13 or some other example herein, wherein said determining the third set of PRACH occasions includes: generating the third set of PRACH occasions by including PRACH occasions of the first set of PRACH occasions and the second set of PRACH occasions.

Example 15 includes the method of any of examples 1-14 or some other example herein, wherein the first set of PRACH occasions partially overlap the second set of PRACH occasions, or the first set of PRACH occasions are a superset of the second set of PRACH occasions, and the method further includes: computing a random access-radio network temporary identifier (RA-RNTI) based on the second set of PRACH occasions.

Example 16 includes the method of any of examples 1-15 or some other example herein, further including: computing a random access-radio network temporary identifier (RA-RNTI) based on an offset.

Example 4 includes the method of any of examples 1-16 or some other example herein, further including: identifying, based the configuration, one or more synchronization signal blocks (SSBs); determining a total number of PRACH occasions associated with each SSB of the one or more SSBs; and performing a prioritization among one or more SSBs based on the total number of PRACH occasions associated with each SSB of one or more SSBs.

Example 18 includes the method of any of examples 1-17 or some other example herein, wherein said performing the prioritization includes: determining that a first total number of PRACH occasions associated with a first SSB is greater than a second total number of PRACH occasions associated with a second SSB; and prioritizing the first SSB over the second SSB based on said determining that the first total number of PRACH occasions associated with the first SSB is greater than the second total number of PRACH occasions associated with the second SSB.

Example 19 includes the method of any of examples 1-18 or some other example herein, wherein said prioritizing the first SSB over the second SSB is based further on:

determining that a first reference signal received power (RSRP) of the first SSB or an RSRP of the second SSB is larger than a threshold.

Example 20 includes the method of any of examples 1-19 or some other example herein, wherein said prioritizing the first SSB over the second SSB is based further on: determining that a difference between a first reference signal received power (RSRP) of the first SSB and an RSRP of the second SSB is larger than a threshold.

Example 21 includes the method of any of examples 1-20 or some other example herein, wherein the total number of PRACH occasions associated with each SSB of one or more SSBs comprises a sum of a number of PRACH occasions of the first set of PRACH occasions associated with the SSB and a number of PRACH occasions of the second set of PRACH occasions.

Example 22 includes the method of any of examples 1-21 or some other example herein, wherein performing the prioritization includes: determining that a first number of PRACH occasions of the first set of PRACH occasions associated with a first SSB is greater than a second number of PRACH occasions of the second set of PRACH occasions associated with a second SSB; and prioritizing the first SSB over the second SSB based on said determining that the first number of PRACH occasions of the first set of PRACH occasions associated with a first SSB is greater than the second number of PRACH occasions of the second set of PRACH occasions associated with a second SSB.

Example 23 includes the method of any of examples 1-22 or some other example herein, wherein said prioritizing the first SSB over the second SSB is based further on: determining that a first reference signal received power (RSRP) of the first SSB or an RSRP of the second SSB is larger than a threshold.

Example 24 includes the method of any of examples 1-23 or some other example herein, wherein said prioritizing the first SSB over the second SSB is based further on: determining that a difference between a first reference signal received power (RSRP) of the first SSB and an RSRP of the second SSB is larger than a threshold.

Example 25 includes the method of any of examples 1-24 or some other example herein, wherein said determining the PRACH occasion includes: randomly selecting a set between the first set of PRACH occasions and the second set of PRACH occasions; and selecting the PRACH occasion from the set.

Example 26 includes the method of any of examples 1-25 or some other example herein, wherein said determining the PRACH occasion includes: determining, based on the configuration, a priority order; selecting a set, based on the priority order, from the first set of PRACH occasions and the second set of PRACH occasions; and selecting the PRACH occasion from the set.

Example 27 includes the method of any of examples 1-26 or some other example herein, wherein said determining the PRACH occasion includes: selecting the PRACH occasion from the first set of PRACH occasions, wherein the first set of PRACH occasions is associated with legacy devices.

Example 28 includes the method of any of examples 1-27 or some other example herein, wherein said determining the PRACH occasion includes: selecting the PRACH occasion from the second set of PRACH occasions, wherein the first set of PRACH occasions is associated with legacy devices.

Example 29 includes the method of any of examples 1-28 or some other example herein, wherein said determining the PRACH occasion includes: identifying a first PRACH occasion from the first set of PRACH occasions; identifying a second PRACH occasion from the set of PRACH occasions; and selecting, as the PRACH occasion, whichever of the first PRACH occasion or the second PRACH occasion occurs earlier in a time domain.

Example 30 includes the method of any of examples 1-29 or some other example herein, wherein the PRACH occasion is a first PRACH occasions, the first PRACH occasion is for a retransmission of a transmission, a second PRACH occasion of a third set of PRACH occasions is associated with the transmission, the third set of PRACH occasions is selected from among the first and second sets of PRACH occasions, and said determining the first PRACH occasion includes: selecting the first PRACH occasion from the third set of PRACH occasions associated with the transmission; or selecting a fourth set of PRACH occasions from among the first and second sets of PRACH occasions and selecting the first PRACH occasion from the fourth set of PRACH occasions.

Example 31 includes a method including: generating a configuration to be transmitted to a user equipment (UE), the configuration including: a first set of parameters associated with a first set of PRACH occasions, the first set of PRACH occasions defined with respect to a second set of PRACH occasions configured for legacy UEs; a second set of parameters associated with a second set of PRACH occasions configured for legacy UEs; a first configuration to map a synchronization signal block (SSB) to the first set of PRACH occasions; and a second configuration to map the SSB to the second set of PRACH occasions; and processing a random access preamble of the UE based on the configuration.

Example 32 includes the method of example 31 or some other example herein, wherein the first set of parameters includes a first frequency offset and the second set of parameters includes a second frequency offset.

Another example may include an apparatus comprising means to perform one or more elements of a method described in or related to any of examples 1-32, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example may include a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a computer program comprising instructions, wherein execution of the program by a processing element is to cause the processing element to carry out the method, techniques, or process as described in or related to any of examples 1-32, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a configuration associated with a random access procedure;
identifying, based on the configuration, a first set of physical random access channel (PRACH) occasions defined with respect to a second set of PRACH occasions configured for legacy user equipments (UEs), wherein the first set of PRACH occasions: do not overlap the second set of PRACH occasions; partially overlap the second set of PRACH occasions; or are a superset of the second set of PRACH occasions;
determining a PRACH occasion based on the first set of PRACH occasions; and
performing the random access procedure on PRACH occasion.

2. The method of claim 1, wherein:
the first set of PRACH occasions do not overlap with the second set of PRACH occasions;
the first set of PRACH occasions are separated from the second set of PRACH occasions in a time domain or in a frequency domain; or
the first set of PRACH occasions is a superset of the second set of PRACH occasions.

3. The method of claim 1, wherein:
the configuration includes a PRACH configuration index and a time offset for the first set of PRACH occasions;
the configuration includes a frequency offset for the first set of PRACH occasions; or
the configuration is to configure individual PRACH occasions of the first set of PRACH occasions with individual time and frequency locations that do not overlap with the second set of PRACH occasions.

4. The method of claim 1, wherein the configuration is to configure the first set of PRACH occasions with a first synchronization signal block (SSB)-to-PRACH occasions mapping that is different from a second SSB-to-PRACH occasions mapping associated with the second set of PRACH occasions.

5. The method of claim 4, wherein the first SSB-to-PRACH occasions mappings comprises a list of one or more SSB indices that are respectively associated with one or more PRACH occasions.

6. The method of claim 1, wherein the first set of PRACH occasions partially overlaps the second set of PRACH occasions and the method further comprises:
determining a third set of PRACH occasions based on the first set of PRACH occasions and the second set of PRACH occasions; and
re-indexing PRACH occasions of the third set of PRACH occasions, wherein said determining the PRACH occasion further includes:
selecting the PRACH occasion from the third set of PRACH occasions.

7. The method of claim 6, wherein:
said re-indexing PRACH occasions of the third set of PRACH occasions includes:
assigning indexes for PRACH occasions of the third set of PRACH occasions first from an increasing order of frequency resource indexes, followed by an increasing order of time resource indexes, followed by an increasing order of slot indexes of PRACH occasions of the third set of PRACH occasions; and
said determining the third set of PRACH occasions includes:
determining that the third set of PRACH occasions includes PRACH occasions of the first set of PRACH occasions that do not overlap with the second set of PRACH occasions;
determining that the third set of PRACH occasions includes PRACH occasions of the first set of PRACH occasions that overlap with the second set of PRACH occasions overlap; and
generating the third set of PRACH occasions by including PRACH occasions of the first set of PRACH occasions and the second set of PRACH occasions.

8. The method of claim 6, further comprising:
computing a random access-radio network temporary identifier (RA-RNTI) based the third set of PRACH occasions and an offset.

9. The method of claim 1, wherein the first set of PRACH occasions partially overlap the second set of PRACH occasions, or the first set of PRACH occasions are a superset of the second set of PRACH occasions, and the method further comprises:
computing a random access-radio network temporary identifier (RA-RNTI) based on the second set of PRACH occasions.

10. The method of claim 1, further comprising:
identifying, based the configuration, one or more synchronization signal blocks (SSBs);
determining a total number of PRACH occasions associated with each SSB of the one or more SSBs; and
performing a prioritization among one or more SSBs based on the total number of PRACH occasions associated with each SSB of one or more SSBs.

11. The method of claim 10, wherein said performing the prioritization comprises:
determining that a first total number of PRACH occasions associated with a first SSB is greater than a second total number of PRACH occasions associated with a second SSB; and
prioritizing the first SSB over the second SSB based on said determining that the first total number of PRACH occasions associated with the first SSB is greater than the second total number of PRACH occasions associated with the second SSB.

12. The method of claim 11, wherein said prioritizing the first SSB over the second SSB is based further on:
determining that a first reference signal received power (RSRP) of the first SSB or an RSRP of the second SSB is larger than a threshold; or
determining that a difference between a first reference signal received power (RSRP) of the first SSB and an RSRP of the second SSB is larger than a threshold.

13. The method of claim 10, wherein the total number of PRACH occasions associated with each SSB of one or more SSBs comprises a sum of a number of PRACH occasions of the first set of PRACH occasions associated with the SSB and a number of PRACH occasions of the second set of PRACH occasions, and said performing the prioritization comprises:
determining that a first number of PRACH occasions of the first set of PRACH occasions associated with a first SSB is greater than a second number of PRACH occasions of the second set of PRACH occasions associated with a second SSB; and
prioritizing the first SSB over the second SSB based on said determining that the first number of PRACH occasions of the first set of PRACH occasions associated with a first SSB is greater than the second number of PRACH occasions of the second set of PRACH occasions associated with a second SSB.

14. The method of claim 13, wherein said prioritizing the first SSB over the second SSB is based further on:
determining that a first reference signal received power (RSRP) of the first SSB or an RSRP of the second SSB is larger than a threshold; or
determining that a difference between a first reference signal received power (RSRP) of the first SSB and an RSRP of the second SSB is larger than a threshold.

15. The method of claim 1, wherein said determining the PRACH occasion comprises:
randomly selecting a set between the first set of PRACH occasions and the second set of PRACH occasions and selecting the PRACH occasion from the set;
determining, based on the configuration, a first priority of the first set of PRACH occasions and a second priority of the second set, selecting, based on the first priority and the second priority, a set from among the first set of PRACH occasions and the second set of PRACH occasions, and selecting the PRACH occasion from the set;
selecting the PRACH occasion from the first set of PRACH occasions, wherein the first set of PRACH occasions is associated with legacy devices;
selecting the PRACH occasion from the second set of PRACH occasions, wherein the first set of PRACH occasions is associated with legacy devices; or
identifying a first PRACH occasion from the first set of PRACH occasions, identifying a second PRACH occasion from the second set of PRACH occasions, and selecting, as the PRACH occasion, whichever of the first PRACH occasion or the second PRACH occasion occurs earlier in a time domain.

16. The method of claim 1, wherein the PRACH occasion is a first PRACH occasions, the first PRACH occasion is for a retransmission of a transmission, a second PRACH occasion of a third set of PRACH occasions is associated with the transmission, the third set of PRACH occasions is selected from among the first and second sets of PRACH occasions, and said determining the first PRACH occasion comprises:
selecting the first PRACH occasion from the third set of PRACH occasions associated with the transmission; or
selecting a fourth set of PRACH occasions from among the first and second sets of PRACH occasions and selecting the first PRACH occasion from the fourth set of PRACH occasions.

17. An apparatus comprising:
processing circuitry to:
process a configuration associated with a random access procedure;
identify, based on the configuration, a first set of physical random access channel (PRACH) occasions defined with respect to a second set of PRACH occasions configured for legacy user equipments (UEs), wherein the first set of PRACH occasions: do not overlap the second set of PRACH occasions; partially overlap the second set of PRACH occasions; or are a superset of the second set of PRACH occasions;
determine a PRACH occasion based on the first set of PRACH occasions; and
perform the random access procedure on PRACH occasion; and
interface circuitry coupled with the processing circuitry to allow communication.

18. The apparatus of claim 17, wherein:
the first set of PRACH occasions do not overlap with the second set of PRACH occasions;
the first set of PRACH occasions are separated from the second set of PRACH occasions in a time domain or in a frequency domain; or
the first set of PRACH occasions is a superset of the second set of PRACH occasions.

19. A method comprising:
generating a configuration to be transmitted to a user equipment (UE), the configuration including:
a first set of parameters associated with a first set of PRACH occasions, the first set of PRACH occasions defined with respect to a second set of PRACH occasions configured for legacy UEs;
a second set of parameters associated with a second set of PRACH occasions configured for legacy UEs;
a first configuration to map a synchronization signal block (SSB) to the first set of PRACH occasions; and
a second configuration to map the SSB to the second set of PRACH occasions; and
processing a random access preamble of the UE based on the configuration.

20. The method of claim 19, wherein the first set of parameters includes a first frequency offset and the second set of parameters includes a second frequency offset.
